(19) United States
(12) Patent Application Publication
(10) Pub. No.: US 2010/0114902 A1
(43) Pub. Date: May 6, 2010

(54) HIDDEN-WEB TABLE INTERPRETATION, CONCEPTULIZATION AND SEMANTIC ANNOTATION

(75) Inventors: David W. Embley, Orem, UT (US); Stephen W. Liddle, Orem, UT (US); Cui Tao, Rochester, MN (US)

Correspondence Address: Workman Nydegger;1000 Eagle Gate Tower, 60 East South Temple, Salt Lake City, UT, 84111, US

(73) Assignee: BRIGHAM YOUNG UNIVERSITY, Provo, UT (US)

(21) Appl. No.: 12/612,590

(22) Filed: Nov. 4, 2009

Related U.S. Application Data
(60) Provisional application No. 61/111,273, filed on Nov. 4, 2008.

(51) Int. Cl. G06F 17/30

(52) U.S. Cl. 707/741; 707/E17.002; 707/758; 707/769; 707/E17.014

(57) ABSTRACT

Indexing hidden web information. First and second web pages are accessed, which include data organized in table format. The tables from the first and second web page are compared. Based on the comparison, a determination is made as to which table cells contain category labels and which contain instance data. The category labels from the first web page are compared to the category labels from the second web page. A general structure of individual tables is inferred based on the act of comparing the category labels. The general structure is chosen from among standard table templates. Data in two or more web pages organized according to the selected table templates is identified. Data from the two or more web pages is stored by associating the table data from two or more web pages to one or more of the selected table templates.

### CROSS-REFERENCE TO RELATED APPLICATIONS

This application claims the benefit of U.S. Provisional application 61/111,273 filed Nov. 4, 2008, titled “HIDDEN-WEB TABLE INTERPRETATION, CONCEPTULIZATION AND SEMANTIC ANNOTATION”, which is incorporated herein by reference in its entirety.

### STATEMENT REGARDING FEDERALLY SPONSORED RESEARCH OR DEVELOPMENT

Supported in part by the National Science Foundation under Grant #0414644

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Computer interconnection has allowed content providers and content consumers to quickly and easily share information. For example, using wide area networks, such as the Internet, a content provider can create a web site which includes content that the content provider would like to share with content consumers. The content consumers can then access the web site to obtain the content. In fact, sharing content has become so simple that huge volumes of content are constantly being created. The sheer amount of content being created has presented additional difficulties. In particular, while the content desired by a content consumer may be freely available on some web site, the content may nonetheless be less accessible or inaccessible in that the content is part of an overall larger amount of content. Thus, content consumers have the proverbial “needle in a haystack” problem.

Additionally, much of the online content available through the Internet, indeed, the vast majority, is stored in databases on the so-called hidden web. In particular, by some estimates, there are more than 500 billion hidden-web pages. The surface web, which is indexed by common search engines only constitutes less than 1% of the World Wide Web. The hidden web is several orders of magnitude larger than the surface web. Hidden-web information is usually only accessible to users through search forms and is typically presented to them in tables. Automatically understanding hidden-web pages is a challenging task.

Tables present information in a simplified and compact way in rows and columns. Data in one row/column usually belongs to the same category or provides values for the same concept. The labels of a row/column describe this category or concept.

Although a table with a simple row and column structure is common, tables can be much more complex. Tables may be nested or conjoined. Labels may span across several cells to give a general description. Sometimes tables are rearranged to fit the space available. Label-value pairs may appear in multiple columns across a page or in multiple rows placed below one another down a page. These complexities make automatic table interpretation challenging.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein is directed to a method practiced in a computing environment. The method includes acts for indexing hidden web information and organizing the information using metadata labels by associating category labels with data values. The method includes one or more computer processors performing various acts. The method includes an act of accessing a first web page. The first web page includes data organized in table format. The method further includes accessing a second web page. The second web page includes data organized in table format. The tables from the first and second web page are compared. Based on the comparison, a determination is made as to which table cells contain category labels and which contain instance data. The category labels from the first web page are compared to the category labels from the second web page. A general structure of individual tables is inferred based on the act of comparing the category labels. The general structure is chosen from among standard table templates. Data in two or more web pages organized according to the selected table templates is identified. Data from the two or more web pages is stored by associating the table data from two or more web pages to one or more of the selected table templates. Storing data includes storing the data in one or more physical computer readable media.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example web page and identification of tables in the web page;

FIG. 2 illustrates a sibling web page to the web page in FIG. 1;

FIG. 3 illustrates a decomposition of the tables in the web page of FIG. 1;

FIG. 4 illustrates DOM trees of portions of the web pages in FIGS. 1 and 2; and

FIG. 5 illustrates a method of indexing hidden web page information and organizing the information using metadata labels by associating category labels with data values.

### DETAILED DESCRIPTION

This application is generally directed to systems, methods and apparatus for distilling knowledge from large networks such as the Internet into useable knowledge that can be more easily searched. For example, embodiments may allow for queries that include keywords, dates, categories, etc. in conjunction with search terms, rather than just queries that only include search terms. In particular, embodiments include functionality for generating a web of knowledge that is overlaid on top of the large network (such as the Internet) where the web of knowledge includes mark-up to web pages to provide context to data stored on the web pages. The mark-up of the web pages can be done by human power, electronic agent power, or a combination of both.

Searching of the large network can then be accomplished by searching based on the mark-up metadata as well as search terms directed to actual data in the web pages. For example, a search may include a specification of metadata such as categories, dates, locations, table header data, etc. in combination with specific search terms. If search terms are found associated with the mark-up metadata, these results can be returned and thus provide more relevant searching functionality.

Mark-up and searches may be implemented using ontology tools and languages. For example, the Web Ontology Language OWL is a semantic markup language for publishing and sharing ontologies on the World Wide Web. OWL is developed as a vocabulary extension of RDF (the Resource Description Framework) and is derived from the DAML+OIL Web Ontology Language. SPARQL (Simple Protocol and RDF Query Language) is an RDF query language. It is considered a component of the semantic web. SPARQL allows for a query to consist of triple patterns, conjunctions, disjunctions, and optional patterns. An RDF query language is a computer language able to retrieve and manipulate data stored in Resource Description Framework format.

Embodiments described herein are particularly directed to interpreting and indexing hidden web information and organizing the information using metadata labels by associating category labels with data values. In one specific example, this can be accomplished by using a computing system to access a first web page. The first web page includes data organized in table format. A second web page can be accessed, where the second web page also includes data organized in table format. The tables from the first and second web page are compared. Based on the comparison, a determination is made as to which table cells contain category labels and which contain instance data. The category labels from the first web page to the category labels from the second web page are compared. A general structure of individual tables is inferred based on the comparison of the category labels. The general structure may be chosen from among standard table templates. Data is identified in two or more web pages organized according to the selected table templates. Data is stored from the one or more web pages by associating the table data from two or more web pages to one or more of the selected table templates.

The World Wide Web serves as a powerful resource for every community. Much of this online information, indeed, the vast majority, is stored in databases on the so-called hidden web. Hidden-web information is usually only accessible to users through search forms and is typically presented to them in tables. Automatically understanding hidden-web pages is a challenging task.

Tables present information in a simplified and compact way in rows and columns. Data in one row/column usually belongs to the same category or provides values for the same concept. The labels of a row/column describe this category or concept.

Although a table with a simple row and column structure is common, tables can be much more complex. Tables may be nested or conjoined. Labels may span across several cells to give a general description. Sometimes tables are rearranged to fit the space available. Label-value pairs may appear in multiple columns across a page or in multiple rows placed below one another down a page. These complexities make automatic table interpretation challenging.

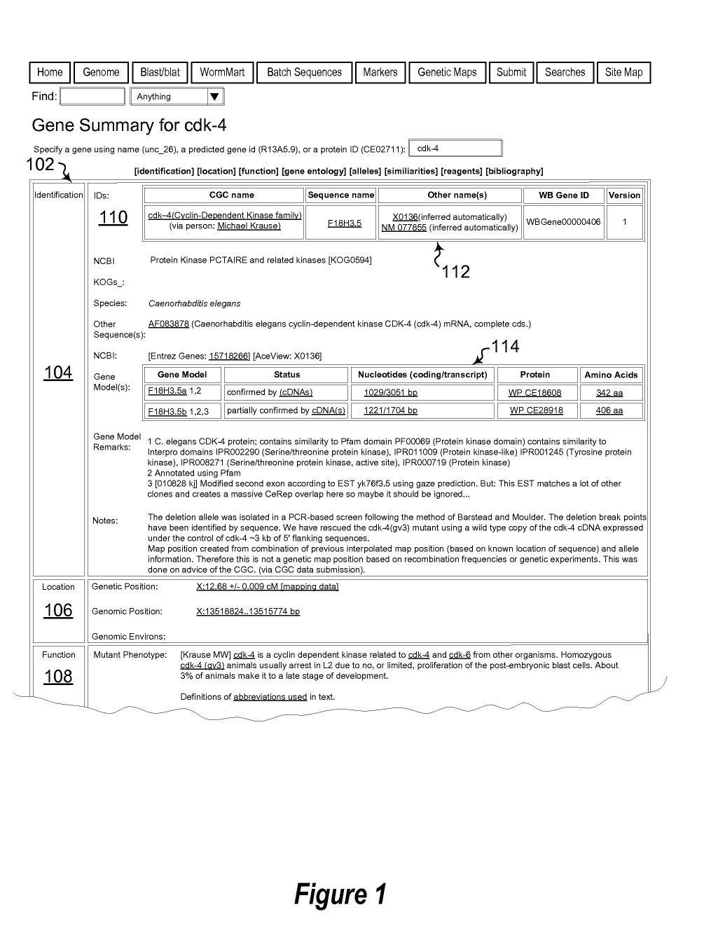

To interpret a table is to properly associate table category labels with table data values. Referring now to FIG. 1, an example of a complex table from www.wormbase.org. Using FIG. 1 as an example, observe a table 102 that includes rows 104, 106 and 108 labeled Identification, Location, and Function respectively. Inside the right cell 110 of the first row 104 is another table with headers: IDs, NCBI KOGs, Species, Other sequence(s), NCBI, Gene model(s), Gene Model Remarks, and Notes. Nested inside of this cell 110 are also are two tables 112 and 114 with labels CGC name, Sequence name, Other name(s), WB Gene ID, Version, and Gene Model, Status, Nucleotides (coding/transcript), Protein, and Amino Acids respectively. Most of the rest of the text in the outermost table 102 comprises the data values. With closer observation, however, one may conclude that some category labels are interleaved in the text. For example, in table 112, via person appears to be a label under CGC name, as does Entrez Genes and Ace View beside NCBI.

Once category labels and data values are found, embodiments should properly associate them. For example, the associated label for the value F18H3.5 should be the sequences of labels Identification, IDs, and Sequence name. Given the source table 102 in FIG. 1, category labels are matched with values. This is illustrated as follows:

```
(Identification.IDs.CGC name) [symbol]
    cdk-4-(Cyclin-Dependent Kinase family)
    (via person: Michael Krause);
(Identification.IDs.Sequence name) [symbol]  F18H3.5;
...
(Identification.Gene model(s).Amino Acids, 2 ) [symbol]  406 aa;
...
```

In this example, one or more sequences of labels are associated with each data value in a table. The left hand side of the arrow is a sequence of one or more table labels, and the right hand side of the arrow is a data value. For the first two label-value pairs illustrated above, there is only one label sequence. The third, however, has two: Identification.Gene model(s).Amino Acids and 2. Each label sequence represents a dimension. In general, a table may have one, two, three, or more dimensions. If a table has multiple records (usually multiple rows) and if the records do not have labels, record numbers are added. The table under Identification.Gene model(s), for example, has two records (two rows), but no row labels. Therefore records are labeled with sequence numbers—the first record 1 and the second record 2. Thus, the label-value association becomes (Identification.Gene model(s).Amino Acids, 2)|→406 aa where Identification.Gene model(s).Amino Acids is the label for the first dimension, and 2 is the row label for the second dimension.

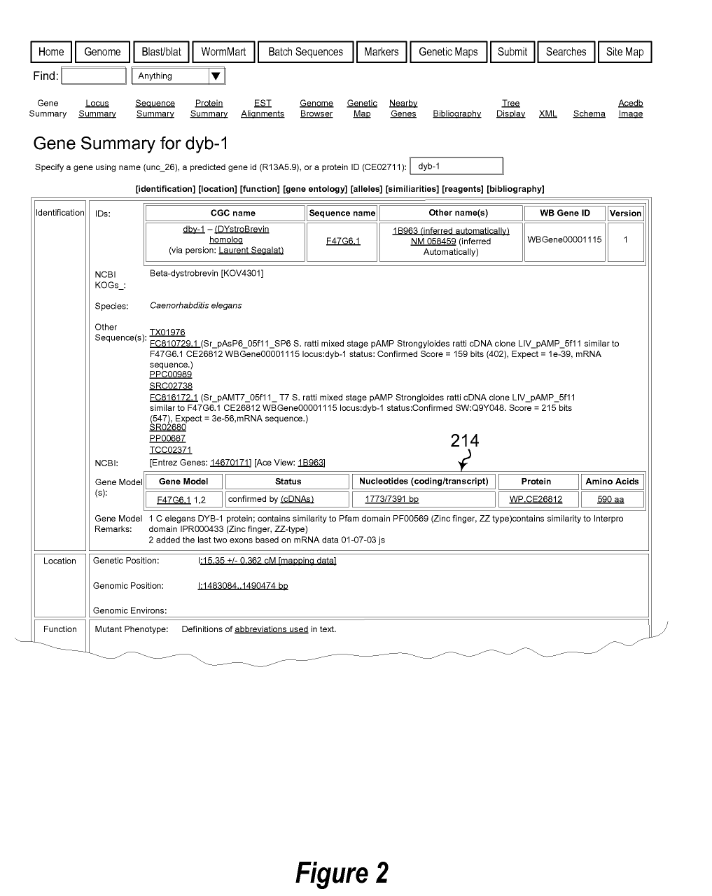

Although automatic table interpretation can be complex, if there is another page, such as the one in FIG. 2, that has essentially the same structure, the system might be able to obtain enough information about the structure to make automatic interpretation possible. Pages are called that are from the same web site and have similar structures sibling pages. Hidden-web pages are usually generated dynamically from a pre-defined templates in response to submitted queries, therefore they are usually sibling pages. The two pages in FIGS. 1 and 2 are sibling pages. They have the same basic structure, with the same top banners that appear in all the pages from this web site, with the same table title (Gene Summary for some particular gene), and a table that contains information about the gene. Corresponding tables in sibling pages are called sibling tables. If the two large tables 102 and 202 are compared in the main part of the sibling pages, it can be observed that the first columns of each table are exactly the same. Examination of the cells under the Identification label in the two tables, both contain another table with two columns. In both cases, the first column contains identical labels IDs, NCBI KOGs, Species, Other sequence(s), NCBI, Gene model(s), Gene Model Remarks, and Notes, Putative ortholog(s). Further, the tables under Identification.IDs also have identical header rows. The data rows, however, vary considerably. Generally speaking, commonalities can be searched for to find labels and look for variations to find data values.

Given that most of the label and data cells can be found in this way, the next task is to infer the general structure pattern of the web site and of the individual tables embedded within pages of the web site. “Structure patterns” are the pattern expressions (path expressions and regular expressions) used to identify the location of tables within an HTML page and to associate table labels with table values. With respect to identified labels, examination can be made below or to the right for value associations. Examinations may also need to be made above or to the left. In FIG. 1, the values for Identification.Gene Model(s).Gene Model are below, and the values for Identification.Species are to the right.

Although a search for commonalities is performed to find labels and look for variations to find data values, being too strict should be avoided. Sometimes there are additional or missing label-value pairs. The two nested tables 114 and 214 whose first column header is Gene Model in FIGS. 1 and 2 do not share exactly the same structure. The table 114 in FIG. 1 has five columns and three rows, while the table 214 in FIG. 2 has six columns and two rows. Although they have these differences, the structure pattern can still be identified by comparing them. The top rows in the two tables are very similar. It is still not difficult to tell that the top rows are rows for labels.

In addition to discovering the structure pattern for a web site, the pattern can also be dynamically adjusted if the system encounters a table that varies from the pattern. If there is an additional or missing label, the system can change the pattern by either adding the new label and marking it optional or marking the missing label optional.

Initial Table Processing. The tags <table> and </table> delimit HTML tables in a web document. In each HTML table, there may be tags that specify the structure of the table. The tag <th> is designed to declare a header, <tr> is designed to declare a row, and <td> is designed to declare a data entry. Unfortunately, users cannot be counted on to consistently apply these tags as they were originally intended. Most table designers simply use the <td> tag for every table entry without regard to whether it is a header or a data value. In addition, a web page designer might use table tags for layout (i.e. to line up columns and rows of symbols, or values, or statements with no thought of table headers, values and their associations). For this case, embodiments may determine that the object delimited by HTML table tags is not a table.

After obtaining a source document, embodiments first parse the source code and locate all HTML components enclosed by <table> and </table> tags (tagged tables). When tagged tables are nested inside of one another, embodiments may find them and unnest them. In FIG. 1, there are several levels of nesting in the large rectangular table 102. The first level is a table with two columns. The first column contains Identification, Location, and Function, and the second column contains some complex structures. FIG. 1 shows three rows of this table—one row for Identification, one for Location, and one for Function. The second column of the large rectangular table 102 in FIG. 1 contains three second-level nested tables, the first starting with IDs, the second with Genetic Position, and the third with Mutant Phenotype. In the right most cell 110 of the first row is another table. There are also two third-level nested tables.

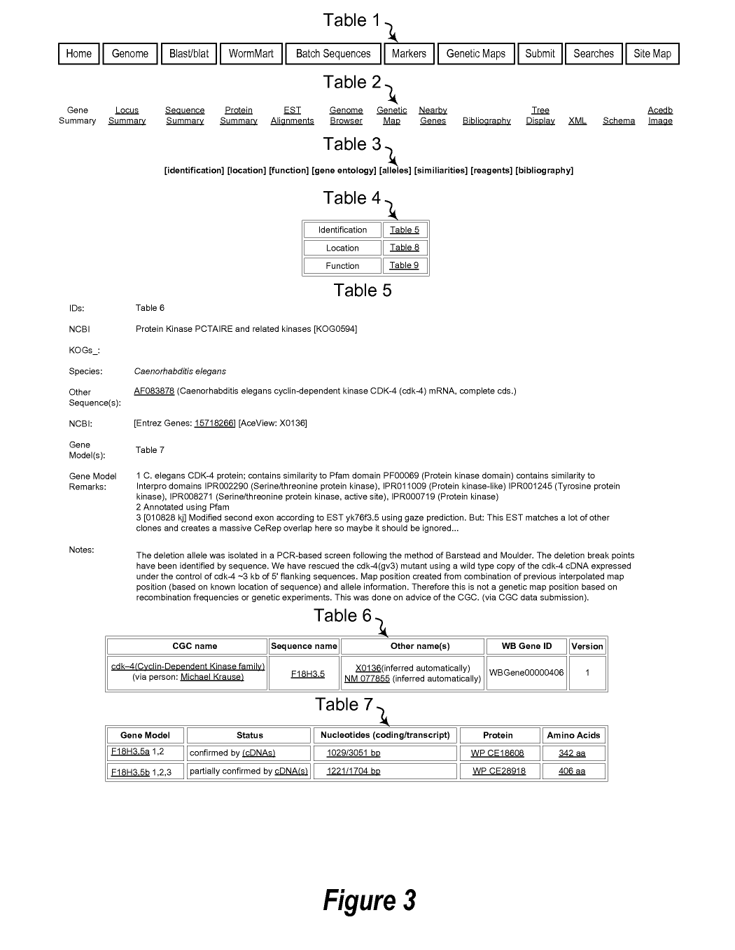

Each tagged table is treated as an individual table and assigned an identifying number to it. If the table is nested, the table is replaced in the upper level with its identifying number. By so doing, the nested tables can be removed from upper level tables. As a result, TISP decomposes the page in FIG. 1 into the set of tables in FIG. 3.

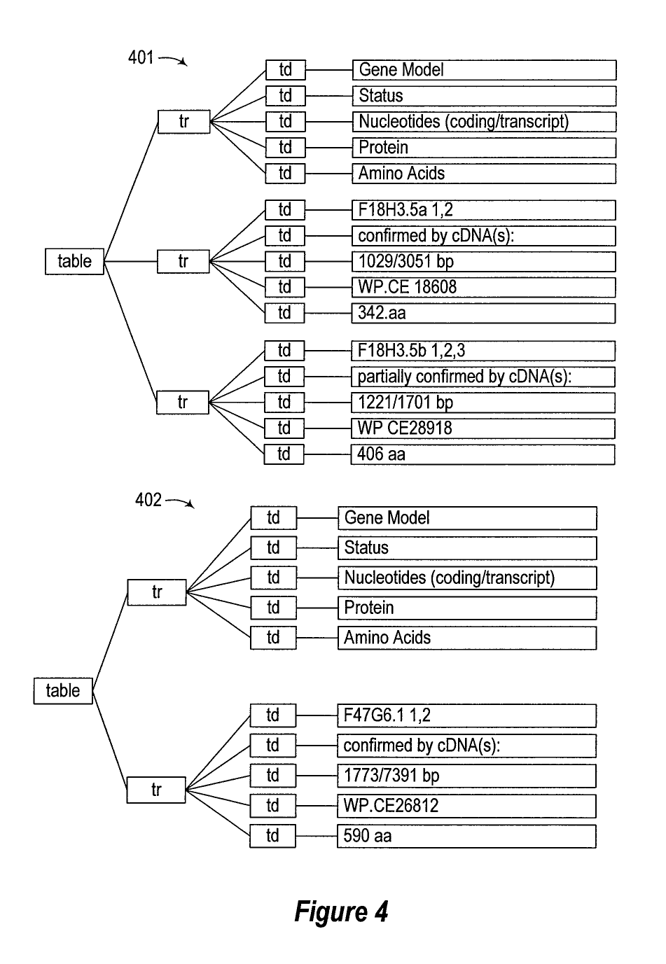

Table Matching. To compare and match tables, each HTML table is transformed into a DOM tree. Tree 401 in FIG. 4 shows the DOM tree for Table 7 in FIG. 3, and tree 402 in FIG. 4 shows the DOM tree for its corresponding table in FIG. 2.

One well acknowledged formal definition of the concept of a tree mapping for labeled ordered rooted trees is as follows:
Let T be a labeled ordered rooted tree and let T[i] be the ith node in level order of tree T. A mapping from tree T to tree T′ is defined as a triple (M, T, T′), where M is a set of ordered pairs (i, j), where i is from T and j is from T′, satisfying the following conditions for all (i₁, j₁), (i₂, j₂)εM, where i₁ and i₂ are two nodes from T and jⱼ and j₂ are two nodes from T′:
   (1) i₁=i₂ iff jᵢ=j₂;
   (2) T[iᵢ] comes before T[i₂] iff T′[jᵢ] comes before T′[j₂] in level order;
   (3) T[iᵢ] is an ancestor of T[i₂] iff T′[j₁] is an ancestor of T′[j₂].

According to this definition, each node appears at most once in a mapping—the order between sibling nodes and the hierarchical relation between nodes being preserved. The best match between two trees is a mapping with the maximum number of ordered pairs.

A tree matching algorithm can be used. In one embodiment, a tree matching algorithm, such as that defined in W. Yang. Identifying syntactic differences between two programs. Software Practice and Experience, 21(7):739-755, 1991, which is incorporated herein by reference in its entirety, can be used. A tree matching algorithm may calculate the similarity of two trees by finding the best match through dynamic programming with complexity O(nᵢn₂), where n₁ is the size (number of nodes) of T and n₂ is the size of T′. This algorithm counts the matches of all possible combination pairs of nodes from the same level, one from each tree, and finds the pairs with maximum matches. The tree match algorithm returns the number of these maximum matched pairs.

The following discussion explains details of one method of performing sibling table identification. In the illustrated embodiment, the results of the tree matching algorithm are used for three tasks: (1) filtering out HTML tables that are only for layout; (2) identifying corresponding tables (sibling tables) from sibling pages; and (3) matching nodes in a sibling table pair.

For each pair of trees, a tree matching algorithm is used to find the maximum number of matched nodes among the two trees. This number is referred to herein as the match score. For each table in one source page, match scores are obtained. Sibling tables should have a one-to-one correspondence. Based on the match scores, sibling tables can be paired. For example, in one embodiment, the Gale-Shapley stable marriage algorithm can be used to pair sibling tables one-to-one from two sibling pages.

For each pair of tables, the sibling table match percentage can be calculated, 100 times the match score divided by the number of nodes of the smaller tree. The match percentage between the two trees in FIG. 4, for example, is 19 (match score) divided by 27 (tree size of Tree₂), which, expressed as a percentage, is 70.4%.

In some embodiments, the table matches are classified into three categories: (1) exact match or near exact match; (2) false match; and (3) sibling-table match. Two threshold boundaries are used to classify table matches: a higher threshold between exact or near exact match and sibling-table match, and a lower threshold between sibling-table match and false match. Usually a large gap exists between the range of exact or near exact match percentages and the range of sibling-table match percentages, as well as between the range of sibling-table match percentages and the range of false match percentages. Some embodiments set the upper threshold at about 90% and the lower threshold at about 20%.

In the present example, Tables 1, 2, and 3 have match percentages of 100% with their sibling tables. The match percentages for Tables 4, 5, 6 and 7, and their corresponding sibling tables, are 66.7%, 58.8%, 69.2%, and 70.4% respectively. Thus, the present example has no false matches using a 90% to 20% threshold. A false match usually happens when a table does not have a corresponding table in the sibling page. In this case, the table may be saved for later comparison. When more sibling pages are compared, a matching table may be found.

Structure Patterns. One component of a structure pattern for a table specifies the table's location in a web page. To specify the location, some embodiments use XPath, which describes the path of the table from the root HTML tag of the document. For example, The location for Table 7 in FIG. 3 is: /html/table[4]/tbody/tr[1]/td[2]/table[2]/tbody/tr[1]/td[2]. An XPath simply lists the nodes (HTML tag names) of a path in a DOM tree for the HTML document where [n] designates the nth sibling node in the ordered subtree.

A second component of a structure pattern specifies the label-value pairs for a table and thus provides the interpretation.

In some embodiments, regular expressions are used to describe table structure pattern templates. If a DOM tree is traversed, which is ordered and labeled, in a preorder traversal, embodiments can layout the tree labels textually and linearly. Regular-expression-like notation can then be used to represent the table structure patterns. In both templates and generated patterns, a standard notation can be used, such as for example: ? (optional), +(one or more repetitions), and |(alternative). In templates, some embodiments augment the notation as follows: a variable (e.g. n) or an expression (e.g. n−1) can replace a repetition symbol to designate a specific number of repetitions; a pair of braces { } indicates a leaf node. A capital letter L is a position holder for a label and a capital letter V is a position holder for value. The part in a box is an atomic pattern which can be used for combinational structural patterns.

The following illustrates three basic pre-defined pattern templates.

Pattern 1:

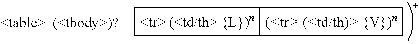

Pattern 2:

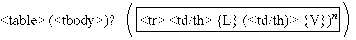

Pattern 3:

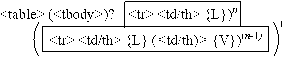

Pattern 1 is for tables with n labels in the first row and with n values in each of the rest of the rows. The association between labels and values is column-wise; the label at the top of the column is the label for all the values in each column. Pattern 2 is for tables with labels in the left-most column and values in the rest of the columns. Each row has a label followed by n values. The label-value association is row-wise; each label labels all values in the row. Pattern 3 is for two-dimensional tables with labels on both the top and the left. Each value in this kind of table associates with both the row header label and the column header label.

To check whether a table matches any pre-defined pattern template, some embodiments test each template until it finds a match. When searching for a matching template, some embodiments only consider leaf nodes and seek matches for labels and mismatches for values. Variations, however, exist and are allowed for. In tables, labels or values are usually grouped. Some embodiments function to identify a structure pattern instead of classifying individual cells. Sometimes a matched node may be found, but all other nodes in the group are mismatched nodes and agree with a certain pattern. In such case embodiments may be configured to ignore the disagreement and assume the matched node is a mismatched node of values as well. Specifically, a template match percentage is calculated between a pre-defined pattern template and a matched result, 100 times the number of leaf nodes that agree with a pattern template divided by total number of leaf nodes in the tree. The template match percentage is calculated between a table and each pre-defined structure template. A match satisfies two conditions: (1) it is the highest match percentage, and (2) the match percentage is greater than a threshold, which in one example is set at 80%.

Consider the mapped result in FIG. 4 as an example. Comparing the template match percentage for this mapped result for the three pattern templates illustrated above, results of 93.3%, 53.3%, and 80% respectively are obtained. Pattern 1 has the highest match percentage, and it is greater than the threshold. Therefore Pattern 1 is selected.

The chosen pattern is then imposed, ignoring matches and mismatches. Note that for tree 401 in FIG. 4, the first branch matches the part in Pattern 1 in the first box, and the second and the third branch each match the part in the second box, where n is five. For Pattern 1, when n=1, there is a one-dimensional table; and when n>1, there is a two-dimensional table for which record numbers are generated.

After embodiments match a table with a pre-defined pattern template, they generate a specific structure pattern for the table by substituting the actual labels for each L and by substituting a placeholder VL for each value. The subscript L for a value V designates the label for the label-value pair for each record in a table. The following shows the specific structure pattern for Table 7 in FIG. 3:

/html/table[4]/tbody/tr[1]/td[2]/table[2]/tbody/tr[1]/td[2]
< table >< tr >
< td > Gene Model
< td > Status
< td > Nucleotides(coding/transcript)
< td > Protein < td > Amino Acids
(< tr >
< td > V_{Gene Model}
< td > V_{Status}
< td > V_{Nucleotides(coding/transcript)}
< td > V_{Protein}
< td > V_{Amino Acids})⁺

With a structure pattern for a specific table, the table and all its sibling tables can be interpreted. The XPath gives the location of the table, and the generated pattern gives the label-value pairs. The pattern should match exactly in the sense that each label string encountered should be identical to the pattern's corresponding label string. Any failure in matching is reported to an appropriate handler.

When the pattern matches exactly, embodiments can generate an interpretation for the table. For the present example, the chosen pattern is Pattern 1 (a table with column headers and one or more data rows). Thus, embodiments add another dimension and add row numbers. Inasmuch as the table is inside of other tables, embodiments recursively search for the tables in the upper levels of nesting and collect all needed labels.

It is possible that embodiments cannot match any pre-defined template. In this case, it looks for pattern combinations. The following table is used for illustration purposes:

| Location | chr8 | Strand | + |
|---|---|---|---|
| Sequence Length | 5095 | Total Exon Length | 2161 |
| Number of Exons | 4 | Number of SNPs | 0 |
| Max Exon Length | 1044 | Min Exon Length | 93 |

Using the preceding table, assume that embodiments match all cells in the first and third column, but none n the second and fourth column. Comparing the template match percentage for this mapped result for the three pattern templates illustrated above, results of 50%, 75%, and 68.8% are obtained respectively. None of these is greater than the threshold, 80%. The first two columns, however match Pattern 2 perfectly, as do the last two columns.

Patterns can be combined row-wise or column-wise. In a row-wise combination, one pattern template can appear after another, but only the first pattern template has the header: <table >(<tbody >)?. Therefore, a row-wise combined structure pattern has a few rows matching one template and other rows matching another template. In a column-wise combination, different atomic patterns can be combined. If a pattern template has two atomic patterns, both patterns should appear in the combined pattern, in the same order, but they can be interleaved with other atomic patterns. If one atomic pattern appears after another atomic pattern from a different pattern template, the <tr> tag at the beginning is removed. The following code illustrates two examples of pattern combinations.

Example 1:
< table > (< tbody >)?
(< tr >< (td|th) >{L}(< (td|th) > {V })ⁿ)⁺
< tr > (< td|th) > fLg)m(< tr > (< (td|th) > fV g)m)+
Example 2:
< table > (< tbody >)?
(< tr >< (tdjth) >fLg(< tdjth) > fV g)n< (tdjth) >fLg(< (tdjth) > fV g)m)+

Example 1 combines Pattern 2 and Pattern 1 row-wise. Example 2 combines Pattern 2 with itself column-wise. This second pattern matches the table above, where n=m=1, and the plus (+) is 4.

The initial search for combinations is similar to the search for single patterns. Embodiments check patterns until they find mismatches, they then check to see whether the mismatched part matches with some other pattern. Some embodiments first search row-wise for rows of labels and then uses these rows as delimiters to divide the table into several groups. If any row of labels cannot be found, the same process is repeated column-wise. Embodiments then try to match each sub group with a pre-defined template. This process repeats recursively until all sub-groups match with a template or the process fails to find any matching template.

For example in table above some embodiments may be unable to find any rows of labels, but may find two columns of labels, the first and third column. One embodiment then divides the table into two groups using these two columns and tries to match each group with a pre-defined template. The embodiment matches each group with Pattern 2. Therefore, this table matches column-wise with Pattern 2 used twice.

Given a structure pattern for a table, it can be determined where the table is in the source document (its XPath), the location of the labels and values, and the association between labels and values. When embodiments encounter a new sibling page, they may try to locate each sibling table following the XPath, and then try to interpret it by matching it with the sibling table structure pattern. If the encountered table matches the structure pattern regular expression perfectly, embodiments successfully interpret this table. Otherwise, embodiments may need to do some pattern adjustment. The following are examples of two ways to adjust a structure pattern: (1) adjust the XPath to locate a table, and (2) adjust the generated structure pattern regular expression.

Although sibling pages usually have the same base structure, some variations might exist. Some sibling pages might have additional or missing tables. Thus, sometimes, following the XPath, we cannot locate the sibling table for which we are looking. In this case, TISP searches for tables at the same level of nesting, looking for one that matches the pattern. If TISP finds one, it obtains the XPath and adds it as an alternative. Thus, for future sibling pages, TISP can (in fact, always does) check all alternative XPaths before searching for another alternative XPath. If TISP finds no matching table, it simply continues its processing with the next table. We adjust a table pattern when we encounter a variation of an existing table. There might be additional or missing labels in the encountered variation. In this case, we need to adjust the structure pattern regular expression, to add the new optional label or to mark the missing label as optional.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

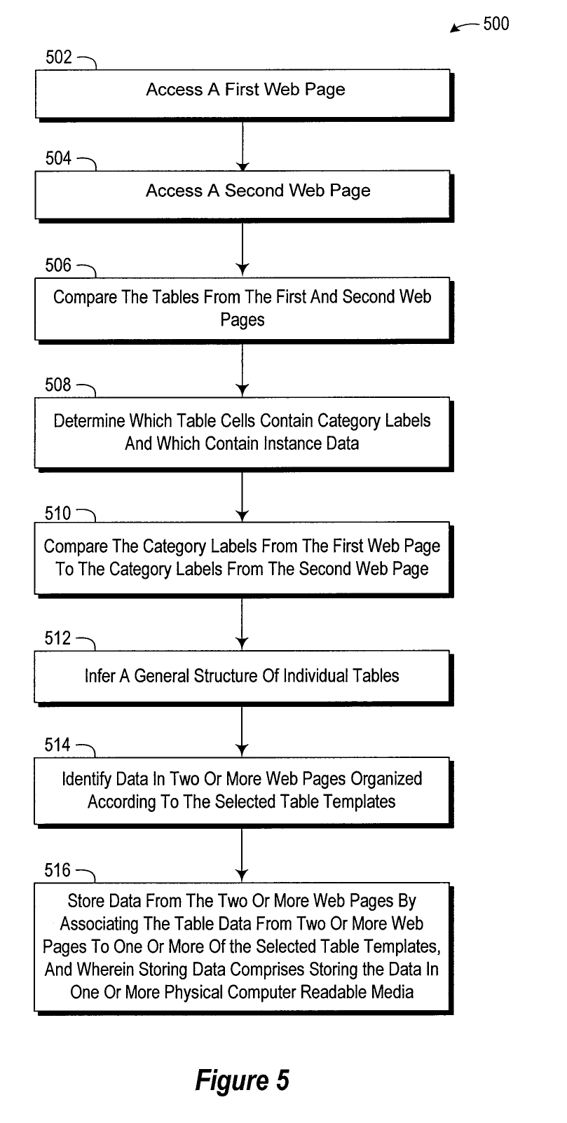

Referring now to FIG. 5, a method 500 is illustrated. The method 500 may be practiced in a computing environment. The method 500 includes acts for indexing hidden web information and organizing the information using metadata labels by associating category labels with data values. The method 500 includes accessing a first web page (act 502). The first web page, in this example includes data organized in table format. The method 500 further includes accessing a second web page (act 504). The second web page also includes data organized in table format. The tables from the first and second web page are compared (act 506). The method 500 further includes determining, based on the comparison, which table cells contain category labels and which contain instance data (act 508). The method 500 further includes comparing the category labels from the first web page to the category labels from the second web page (act 510). The method 500 further includes inferring a general structure of individual tables based on the act of comparing the category labels (act 512). The general structure may be chosen from among standard table templates. The method 500 further includes identifying data in two or more web pages organized according to the selected table templates (act 514). The method 500 further includes storing data from the two or more web pages by associating the table data from two or more web pages to one or more of the selected table templates (act 516). Storing data may include storing the data in one or more physical computer readable media.

The method 500 may be practiced where the acts are performed based on identifying tables in the first web page as sibling tables in the second web page.

The method 500 may be practiced where the first web page and the second web page belong to the same web site.

The method 500 may further include identifying optional category labels by identifying either extra category labels included in the first web page and not included in the second web page, or by identifying category labels not included in the first web page that are included in the second web page.

The method 500 may further include identify optional labels by accessing one or more additional web pages in the same web site and identifying either extra category labels included in additional web pages and not included in the selected category labels, or by identifying labels included in the selected category labels and not included in additional web pages.

The method 500 may further include saving the general structure as an OWL ontology.

The method 500 may be practiced where identifying category labels Includes parsing source code to find table tags. For example, HTML code may be parsed to find tags such as <table> and </table> which delimit HTML tables in a web document, tags such as <th> which is designed to declare a header, <tr> which is designed to declare a row, and <td> is designed to declare a data entry.

The method 500 may be practiced where identifying category labels comprises un-nesting nested tables.

The method 500 may further include transforming HTML tables to DOM trees to facilitate comparing the tables from the first web page to tables from the second web page and subsequent web pages in the same web site.

The method 500 may further include filtering out layout tables.

The method 500 may further include receiving a query from a user. The query includes information about one or more category labels or search terms. A determination is made determining if stored data corresponds to the one or more category labels or search terms. If stored data corresponds to the one or more category labels or search terms, the stored data is returned to the user. In some embodiments, the query may include a natural language query. The method may further include extracting information about one or more category labels or search terms from the query. In an alternative embodiment, the query may be a SPARQL query over the category labels or search terms.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of indexing hidden web information and organizing the information using metadata labels by associating category labels with data values, the method comprising, one or more computer processors performing the following:
accessing a first web page, the first web page including data organized in table format;
accessing a second web page, the second web page including data organized in table format;
comparing the tables from the first and second web page;
determining, based on the comparison, which table cells contain category labels and which contain instance data;
comparing the category labels from the first web page to the category labels from the second web page;
inferring a general structure of individual tables based on the act of comparing the category labels, the general structure being chosen from among standard table templates;
identifying data in two or more web pages organized according to the selected table templates; and
storing data from the two or more web pages by associating the table data from two or more web pages to one or more of the selected table templates, and wherein storing data comprises storing the data in one or more physical computer readable media.

2. The method of claim 1, wherein the acts are performed based on identifying tables in the first web page as sibling tables in the second web page.

3. The method of claim 1, wherein the first web page and the second web page belong to the same web site.

4. The method of claim 1, further comprising identifying optional category labels by identifying either extra category labels included in the first web page and not included in the second web page, or by identifying category labels not included in the first web page that are included in the second web page.

5. The method of claim 1, further comprising identify optional labels by accessing one or more additional web pages in the same web site and identifying either extra category labels included in additional web pages and not included in the selected category labels, or by identifying labels included in the selected category labels and not included in additional web pages.

6. The method of claim 1, further comprising saving the general structure as an OWL ontology.

7. The method of claim 1, wherein identifying category labels comprises parsing source code to find table tags.

8. The method of claim 1, wherein identifying category labels comprises un-nesting nested tables.

9. The method of claim 1, further comprising transforming HTML tables to DOM trees to facilitate comparing the tables from the first web page to tables from the second web page and subsequent web pages in the same web site.

10. The method of claim 1, further comprising filtering out layout tables.

11. The method of claim 1, further comprising:
receiving a query from a user, the query comprising information about one or more category labels or search terms;
determining if stored data corresponds to the one or more category labels or search terms; and
if stored data corresponds to the one or more category labels or search terms, returning the stored data to the user.

12. The method of claim 11, wherein the query comprises a natural language query and wherein the method further comprises extracting information about one or more category labels or search terms from the query.

13. The method of claim 11, wherein the query is a SPARQL query over the category labels or search terms.

14. A computing system comprising one or more computer processors, the system including functionality for indexing hidden web information and organizing the information using metadata labels by associating category labels with data values, the system comprising:
a computer module configured to access a first web page, the first web page including data organized in table format;
a computer module configured to access a second web page, the second web page including data organized in table format;
a computer module configured to compare the tables from the first and second web page;
a computer module configured to determine, based on the comparison, which table cells contain category labels and which contain instance data;
a computer module configured to compare the category labels from the first web page to the category labels from the second web page;
a computer module configured to infer a general structure of individual tables based on comparing the category labels, the general structure being chosen from among standard table templates;
a computer module configured to identify data in two or more web pages organized according to the selected table templates; and
a computer module configured to for store data from the two or more web pages by associating the table data from two or more web pages to one or more of the selected table templates, and wherein storing data comprises storing the data in one or more physical computer readable media

15. The system of claim 14, further comprising a computer module configured to identify optional category labels by identifying either extra category labels included in the first web page and not included in the second web page, or by identifying category labels not included in the first web page that are included in the second web page.

16. The system of claim 14, further comprising a computer module configured to identify optional labels by accessing one or more additional web pages in the same web site and identify either extra category labels included in additional web pages and not included in the selected category labels, or by identifying labels included in the selected category labels and not included in additional web pages.

17. The system of claim 14, further comprising a computer module configured to save the general structure as an OWL ontology.

18. The system of claim 14, further comprising a computer module configured to transform HTML tables to DOM trees to facilitate comparing the tables from the first web page to tables from the second web page and subsequent web pages in the same web site.

19. The system of claim 14, further comprising:
a computer module configured to receive a query from a user, the query comprising information about one or more category labels or search terms; and
a computer module configured to determine if stored data corresponds to the one or more category labels or search terms and if stored data corresponds to the one or more category labels or search terms, return the stored data to the user.

20. In a computing environment, a computer program product comprising one or more physical computer readable media, the one or more physical computer readable media storing thereon computer executable instructions that when executed by one or more processors perform the following:
accessing a first web page, the first web page including data organized in table format;
accessing a second web page, the second web page including data organized in table format;
comparing the tables from the first and second web page;
determining, based on the comparison, which table cells contain category labels and which contain instance data;
comparing the category labels from the first web page to the category labels from the second web page;
inferring a general structure of individual tables based on the act of comparing the category labels, the general structure being chosen from among standard table templates;
identifying data in two or more web pages organized according to the selected table templates; and
storing data from the two or more web pages by associating the table data from two or more web pages to one or more of the selected table templates, and wherein storing data comprises storing the data in one or more physical computer readable media
